(19) United States
(12) Patent Application Publication
(10) Pub. No.: US 2025/0117954 A1
(43) Pub. Date: Apr. 10, 2025

(54) SYSTEM, METHOD, AND INFORMATION STORAGE MEDIUM STORING PROGRAM FOR GENERATING DEPTH MAPS

(71) Applicant: Japan Display Inc., Tokyo (JP)

(72) Inventor: Hitoshi TANAKA, Tokyo (JP)

(73) Assignee: Japan Display Inc., Tokyo (JP)

(21) Appl. No.: 18/906,181

(22) Filed: Oct. 4, 2024

(30) Foreign Application Priority Data
Oct. 4, 2023 (JP) 2023-173151

(51) Int. Cl. G06T 7/50

(52) U.S. Cl. CPC G06T 7/50

(57) ABSTRACT

A generation system includes a liquid crystal shutter that forms a coded aperture part and a depth calculating unit that uses a captured image acquired by an imaging device to calculate a depth for each unit area of a depth map. The coded aperture part includes an aperture pattern including a transmissive area having a first light transmittance, a semi-transmissive area having a second light transmittance lower than the first light transmittance, and a shielding area having a third light transmittance lower than the second light transmittance. This serves to reduce the number of times of capturing an object required for generating a depth map, thereby increasing situations in which the generation system is used.

### CROSS-REFERENCE TO RELATED APPLICATION

The present application claims priority from Japanese application No. 2023-173151 filed on Oct. 4, 2023, the content of which is hereby incorporated by reference into this application.

### BACKGROUND OF THE INVENTION

### 1. Field of the Invention

The present invention relates to a system, a method, and an information-storage medium storing a program for generating a depth map.

### 2. Description of the Related Art

A paper described below proposes a technique for generating a depth map from an image captured through a coded aperture. In the paper, two coded apertures having different aperture patterns (that is, shapes of transmissive areas and shielding areas) are used. The coded aperture can be formed of a liquid crystal shutter. The two coded apertures are used in combination thereof to prevent a filter that is used in a process for generating a depth map (that is, a filter for generating a restored image) from having a frequency band in which a power spectrum is zero. “C. Zhou, S. Lin, and S. Nayar: Coded Aperture Pairs for Depth from Defocus and Defocus Deblurring, IEEE international conference on computer vision, 2009”

However, the method using two coded apertures as proposed in the paper requires to capture an image of objects twice, using the two coded apertures respectively. Accordingly, the objects need to stand still while being captured twice, which restricts the scene in which such a method can be used. Even if the operation speed of the liquid crystal shutter is increased and the exposure time is shortened, it is difficult to use such a method to capture a moving image, for example.

### SUMMARY OF THE INVENTION

A system for generating a depth map proposed in the present disclosure includes a liquid crystal shutter that forms a coded aperture part, an imaging device that captures light transmitted through the coded aperture part, and a depth calculating unit that uses a captured image acquired by the imaging device to calculate a depth for each unit area of a depth map. An aperture pattern of the coded aperture part includes a first area having a first light transmittance, a second area having a second light transmittance lower than the first light transmittance, and a third area having a third light transmittance lower than the second light transmittance.

A method for generating a depth map proposed in the present disclosure includes the steps of forming a coded aperture part with a use of a liquid crystal shutter, capturing light transmitted through the coded aperture part, and using a captured image acquired by the imaging device to calculate a depth for each unit area in the depth map. In the step of forming the coded aperture part, an aperture pattern including a first area having a first light transmittance, a second area having a second light transmittance lower than the first light transmittance, and a third area having a third light transmittance lower than the second light transmittance is formed.

A program proposed in the present disclosure causes a computer to function as means for forming a coded aperture part with a use of a liquid crystal shutter, means for capturing light transmitted through the coded aperture part, and means for using a captured image acquired by the imaging device to calculate a depth for each unit area of the depth map. The means for forming the coded aperture part forms an aperture pattern that includes a first area, a second area, and a third area, where the first area has a first light transmittance, the second area has a second light transmittance lower than the first light transmittance, and the third area has a third light transmittance lower than the second light transmittance.

According to the system for generating a depth map, the method for generating a depth map, and the program proposed in the present disclosure, the number of times of capturing an object required for generating a depth map can be set to one, for example, and situations in which the generation system is used can be thereby increased.

### BRIEF DESCRIPTION OF THE DRAWINGS

FIG. 1 is a sectional view of an imaging system of a system for generating a depth map;

FIG. 2 is a block diagram showing hardware of the system for generating the depth map;

FIG. 3 is a block diagram showing functions of a control unit of the system for generating the depth map;

FIG. 4 is a diagram showing an example of an aperture pattern of a coded aperture;

FIG. 5 is a diagram for explaining the function of the aperture pattern shown in FIG. 4;

FIG. 6 is a flowchart showing an example of processing executed by the control unit;

FIG. 7 is a diagram explaining processing for calculating an estimated depth;

FIG. 8 is a diagram for explaining processing performed by a depth calculating unit;

FIG. 9 is a diagram for explaining the function of the aperture pattern shown in FIG. 4, and shows the aperture pattern having a transmissive area having a radius “a” at the central area; and

FIG. 10 shows a modified example of the aperture pattern.

### DETAILED DESCRIPTION OF THE INVENTION

A system, a method, and a program for generating a depth map proposed in the present disclosure will be discussed.

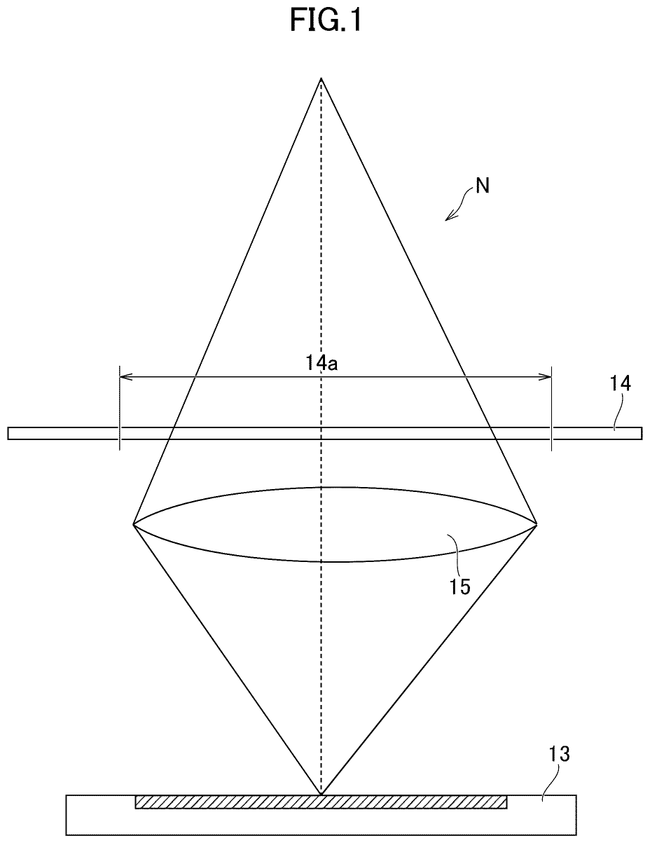

Hardware of generation system for depth map FIG. 1 is a cross-sectional view of an imaging system N of a generation system 10 as an example of the generation system of a depth map proposed in the present disclosure. As shown in FIG. 1, the generation system 10 includes a liquid crystal shutter 14 and an image device 13.

The imaging device 13 is an image sensor such as a CMOS (complementary metal oxide semiconductor) sensor and a CCD (charge coupled device).

The liquid crystal shutter 14 includes a plurality of pixels. A coded aperture part 14a is formed in a part of the liquid crystal shutter 14. A control unit 11 to be described below drives liquid crystal of the coded aperture part 14a so as to form a predefined aperture pattern. The aperture pattern will be described later in detail.

As shown in FIG. 1, the generation system 10 may have a lens 15 placed between the coded aperture part 14a and the imaging device 13. Light passing through the coded aperture part 14a and the lens 15 enters the imaging device 13.

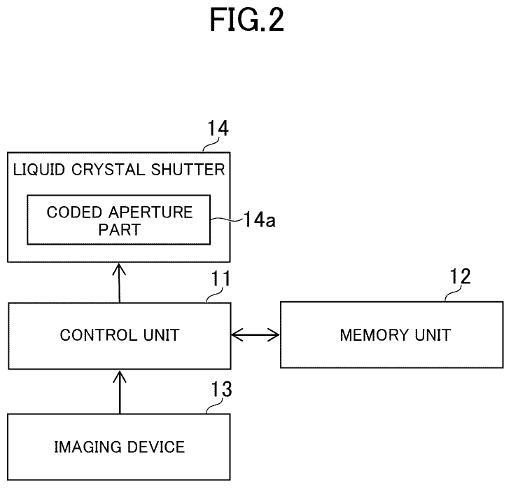

FIG. 2 is a block diagram showing the hardware of the generation system 10. The generation system 10 includes the liquid crystal shutter 14, the imaging device 13, and the lens 15 shown in FIG. 1 and also a control unit 11, a memory unit 12, and an input unit 16.

The control unit 11 includes at least one processor such as a CPU (central processing unit) or a GPU (graphical processing unit). The image data acquired by the imaging device 13 is provided to the control unit 11. The control unit 11 uses the image data to generate a depth map indicating the distance to an object.

The memory unit 12 includes a main memory unit and an auxiliary memory unit. For example, the main memory unit is a volatile memory such as RAM (random access memory), and the auxiliary memory unit is a non-volatile memory such as a ROM (read only memory), an EEPROM (electrically erasable and programmable read only memory), a flash memory, and a hard disk. The control unit 11 executes a program stored in the memory unit 12 to control the liquid crystal shutter 14 and calculates depths (distances to the object). Processing executed by the control unit 11 will be discussed later.

The generation system 10 may be a portable device, such as a smartphone and a tablet PC (personal computer), or a personal computer connected to a camera.

The input unit 16 may be a touch sensor attached to the liquid crystal shutter 14. The input unit 16 may be a pointing device, such as a keyboard and a mouse. The input unit 16 inputs a signal according to an operation of a user to the control unit 11.

### Functions of Generation System

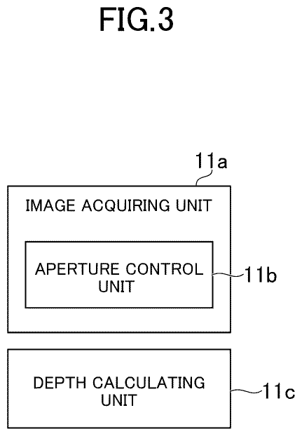

FIG. 3 is a block diagram showing functions of the control unit 11. The control unit 11 functionally includes an image acquiring unit 11a and a depth calculating unit 11c. The image acquiring unit 11a includes an aperture control unit 11b. These functions are implemented by the control unit 11 operating according to a program stored in the memory unit 12.

The aperture control unit 11b controls the liquid crystal shutter 14 to form a predefined aperture pattern and forms a coded aperture part 14a. The image acquiring unit 11a controls the imaging device 13 and the coded aperture part 14a to capture an image f through the coded aperture part 14a (hereinafter, the image f is referred to as a captured image).

### Aperture Pattern

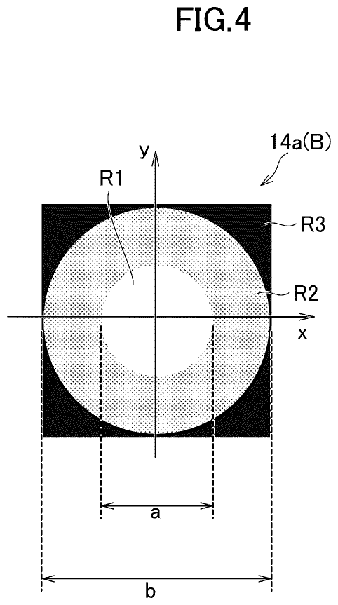

FIG. 4 is a diagram illustrating an example of an aperture pattern B formed by the coded aperture part 14a. As shown in FIG. 4, the aperture pattern B includes a transmissive area R1 that transmits light and a shielding area R3 that shields light. The aperture pattern B includes a semi-transmissive area R2 in addition to the transmissive area R1 and the shielding area R3. The transmissive area R1, the semi-transmissive area R2, and the shielding area R3 respectively have light transmittances T1, T2, and T3. For example, the light transmittance T1 is the upper limit of the adjustment range of the light transmittance by the liquid crystal shutter 14, and the light transmittance T3 is the lower limit of the adjustment range of the light transmittance by the liquid crystal shutter 14. That is, for example, the light transmittance T1 is the upper limit (100%) of the light transmittance that the aperture control unit lib can achieve by the liquid crystal shutter 14, and the light transmittance T3 is the lower limit (0%) of the light transmittance that the aperture control unit lib can achieve by the liquid crystal shutter 14. The light transmittance T2 is the transmittance between the light transmittance T1 and the light transmittance T3. That is, these light transmittances have a relationship of T1>T2>T3. In a case where the light transmittances T1 and T3 are 100% and 0%, respectively, the light transmittance T2 may be 40% to 60%, for example. More specifically, the light transmittance T2 may be substantially intermediate (50%) between the light transmittances T1 and T3.

The light transmittance T1 (100%) does not necessarily mean that all of the light entering the transmissive area R1 passes through the transmissive area R1. A part of the light entering the transmissive area R1 may be absorbed by or reflected by the liquid crystal shutter 14. Further, the light transmittance T3 (0%) does not necessarily mean that all of the light entering the shielding area R3 does not pass through the shielding area R3. A part of the light entering the shielding area R3 may be transmitted through the liquid crystal shutter 14.

Each of the transmissive area R1 and the semi-transmissive area R2 may be circular or annular having the same center, for example. In the example shown in FIG. 4, the semi-transmissive area R2 has an outer diameter larger than that of the transmissive area R1. That is, the transmissive area R1 is located inside the semi-transmissive area R2. The semi-transmissive area R2 is annular. The shielding area R3 is formed on the outer side of the semi-transmissive area R2.

The shapes of the transmissive area R1, the semi-transmissive area R2, and the shielding area R3 are not limited to those shown in FIG. 4. For example, the transmissive area R1 may be annular, and the semi-transmissive area R2 may be formed inside the transmissive area R1.

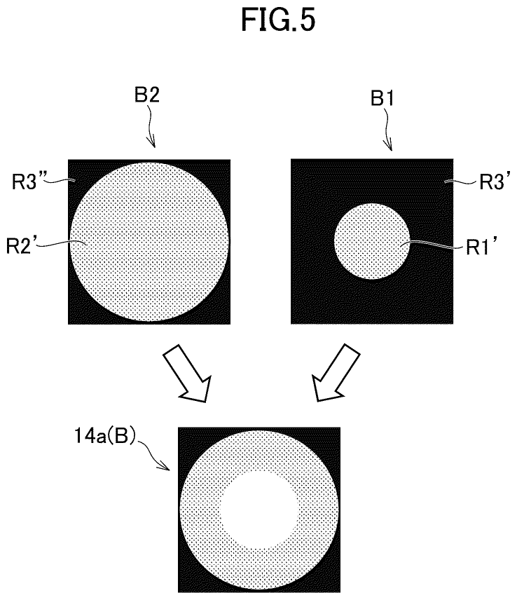

The point spread function (PSF) corresponding to the aperture pattern B having three areas R1, R2, and R3 having different transmittances is substantially the same as the sum of the two PSFs respectively corresponding to the two different aperture patterns. Referring to FIG. 5, the PSF corresponding to the aperture pattern B shown in FIG. 4 is substantially the same as the sum of PSFs corresponding to the two different aperture patterns B1 and B2. The aperture pattern B1 shown in FIG. 5 has a shielding area R3′ having the same size and shape as the shielding area R3 shown in FIG. 4, and a semi-transmissive area R1′ (area having 50% light transmittance) having the same size and shape as the transmissive area R1 shown in FIG. 4. The aperture pattern B2 shown in FIG. 5 has a shielding area R3″ and a semi-transmissive area R2′ (area having 50% light transmittance) having the same size as the semi-transmissive area R2 shown in FIG. 4. With the coded aperture part 14a having such an aperture pattern B, it is possible to calculate substantially the same depth as the depth calculated from two images obtained through the two coded apertures respectively having the aperture pattern B1 and the aperture pattern B2. The images may be captured only one time through the coded aperture part 14a. As such, situations in which the generation system 10 is used can be increased as compared to a system using two coded aperture parts. The function of the aperture pattern B having the semi-transmissive area R2 will be described later.

### Calculation of Estimated Depth

The depth calculating unit 11c generates a depth map from the captured image f acquired by the image acquiring unit 11a. The depth calculating unit 11c calculates, for each of a plurality of unit areas forming the depth map, depths of the captured image f. (The depths means the distances from the imaging system N to an object in the captured image f.) The unit area of the depth map may be each pixel in the captured image f. Alternatively, the unit area may be an area including a plurality of pixels in the captured image f, for example. That is, the unit area of the depth map may include a plurality of pixels (e.g., 2×2, 3×3) adjacent to one another, for example.

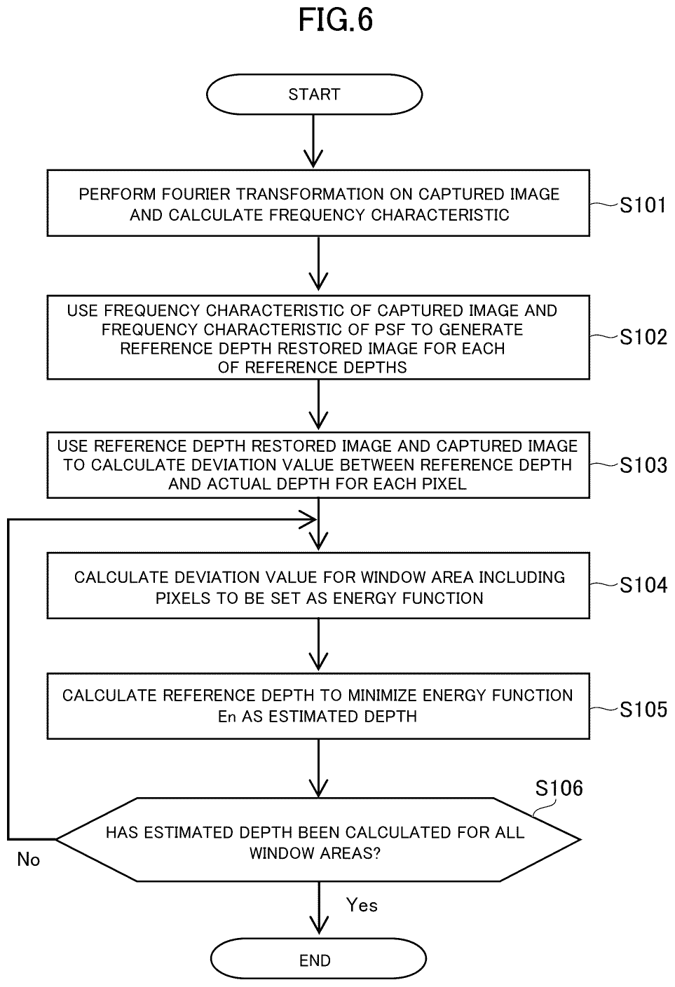

FIG. 6 is a flowchart showing an example of processing of the depth calculating unit 11c. The processing of the depth calculating unit 11c shown in FIG. 5 starts after the captured image f is acquired by the image acquiring unit 11a.

First, the depth calculating unit 11c performs a two-dimensional Fourier transformation on the captured image f to transform the captured image into frequency domain (S101). In the following, the frequency characteristic of the captured image f obtained by the two-dimensional Fourier transformation is described as F.

In the generation system 10, a plurality of point spread functions (PSFs) are prepared, which respectively corresponding to a plurality of reference depths defined discretely. The reference depth is a candidate value of a distance to the object, such as 100 mm, 200 mm, and 300 mm. The PSFs have shapes corresponding to the aperture pattern B of the coded aperture 14a. Each PSF has a size corresponding to the reference depth corresponding thereto. As the reference depth is larger, the PSF is reduced in size. The memory unit 12 stores the PSFs in frequency domain. That is, the memory unit 12 stores PSFs as their frequency characteristics obtained by performing two-dimensional Fourier transformation of the PSFs. The depth calculating unit 11c acquires such PSFs as the frequency characteristic from the memory unit 12. The frequency characteristic of PSF is also referred to as an optical transfer function (OTF). Each PSF corresponding to aperture pattern B is the sum of the PSF corresponding to aperture pattern B1 and the PSF corresponding to aperture pattern B2, as shown in FIG. 5. This is demonstrated by Mathematical formula 14, which will be discussed later. Mathematical formula 14 shows the relationship between the PSFs corresponding to aperture patterns B, B1, and B2, expressed in the frequency domain. Therefore, even with a single aperture pattern B, it is possible to suppress the occurrence of frequency where the power spectrum becomes zero when generating a restored image using the PSF.

The depth calculating unit 11c uses the captured image f and the PSF to generate a restored image corresponding to the reference depth for each of the reference depths (S102). Hereinafter, the restored image is referred to as “reference depth restored image”. Specifically, the depth calculating unit 11c uses Mathematical formula 1 below to calculate the frequency characteristic of the reference depth restored image according to the frequency characteristic F of the captured image f and the frequency characteristic of the PSF.

$${F}_{n} = \frac{F \cdot \overline{{K}_{n}}}{{\vert {K}_{n} \vert}^{2} + {η}^{2} α {\sum }_{k} {\vert {G}_{k} \vert}^{2}} \qquad Mathematical formula 1$$

In Mathematical formula 1, characters represent the following elements:
Fₙ: a reference depth restored image expressed by a frequency domain, that is a frequency characteristic of the reference depth restored image
F: a captured image expressed by a frequency domain, that is a frequency characteristic of the captured image f obtained by the first aperture pattern B
Kₙ: frequency characteristics (optical transfer function) of the PSF having the shape corresponding to the aperture pattern B and corresponding to the n-th size;
η: a noise term when the noise occurrence probability in each pixel follows a Gaussian distribution (e.g., η=0.005)
α: variance of a first derivative of pixel values (the variance α is set to match a first derivative of pixel values in a natural image, and is 250, for example)
Σₖ|Gₖ|: the sum of the absolute value of the frequency characteristic of the first derivative filter along the X direction (horizontal direction of the captured image) and the absolute value of the frequency characteristic of the first derivative filter along the Y direction (vertical direction of the captured image)
Kₙ with overline: conjugate complex numbers of the frequency characteristics Kₙ of PSFs
   “Mathematical formula 1” is derived from Equation (11) presented in the following paper:
   Anat Levin, Rob Fergus, Fredo Durand, William T. Freeman, Image and Depth from a Conventional Camera with a Coded Aperture, ACM Transactions on Graphics, Vol. 26, No. 3, Article 70, Publication date: July 2007.

The sizes of the PSFs decrease as the distance (depth) from the imaging system N to the object increases. As such, the frequency characteristics Kₙ of the PSFs are defined according to the distance from the imaging system N to the object. In Mathematical formula 1, a subscript “n” attached to Kₙ is a natural number such as 1, 2, 3, . . . and each corresponds to a reference depth D such as 100 mm, 200 mm, and 300 mm. For example, the frequency characteristic K₁ is a frequency characteristic of the PSF for an object placed at a 100 mm distance from the imaging system N, and the frequency characteristic K₂ is a frequency characteristic of the PSF for an object placed at a 200 mm distance from the imaging system N. The number of reference depths is 10, 20, and 30, for example, and may be determined according to the resolution of the depth map.

In S102, the depth calculation unit 11c uses Mathematical formula 1 to calculate frequency characteristic Fₙ of the reference depth restored image according to the frequency characteristics F of the captured image f and the frequency characteristics Kₙ of the PSF. That is, the depth calculating unit 11c uses the frequency characteristics K₁, K₂, K₃, . . . of the PSF respectively corresponding to the reference depths and the frequency characteristic F of the captured image f to calculate the frequency characteristic Fₙ of the reference depth restored images. For example, the depth calculating unit 11c calculates the frequency characteristic F₁ of the reference depth restored image based on the frequency characteristic K₁ and the frequency characteristic F of the captured image f, and calculates the frequency characteristic F₂ of the reference depth restored image based on the frequency characteristic K₂ and the frequency characteristic F of the captured image f.

With the use of Mathematical formula 1, the object at the distance from the imaging system N equal to the reference depth is clearly displayed in the reference depth restored image. For example, an object placed at 100 mm from the imaging system N clearly appears in the reference depth restored image (F₁) obtained by the PSF (frequency characteristic K₁) corresponding to “reference depth: 100 mm”. On the other hand, ringing (blurring) appears for the same object in the reference depth restored image obtained by the PSF corresponding to other reference depths, such as 200 mm and 300 mm. As such, the depth calculating unit 11c calculates and searches for a reference depth in which ringing is minimal for each of the unit areas of the depth map. Hereinafter, the reference depth calculated in this manner is referred to as an estimated depth.

The depth calculating unit 11c performs an inverse Fourier transformation on the frequency characteristic Fₙ of the reference depth restored image to generate a reference depth restored image fₙ. That is, the depth calculating unit 11c transforms the frequency characteristic Fₙ into the spatial domain. The depth calculating unit 11c then uses the reference depth restored image fₙ and the captured image f to calculate a value (deviation value) corresponding to the degree of deviation between the reference depth and the actual depth for each pixel (S103). For example, the depth calculating unit 11c calculates the deviation value using Mathematical formula 2 below.

$${e}_{n} = f - {k}_{n} * {f}_{n} \qquad Mathematical formula 2$$

In Mathematical formula 2, characters represent the following elements:
eₙ: deviation value
f: captured image
kₙ: a point spread function (PSF) corresponding to the aperture pattern B and having n-th size
fₙ: an inverse Fourier transformation of a reference depth restored image Fₙ obtained using Mathematical formula 1
kₙ*fₙ: convolution of kₙ and fₙ

If the n-th reference depth matches the actual depth, the pixel value of the image obtained by kₙ˜*fₙ is substantially the same as the pixel value of the captured image f, and the deviation value eₙ is substantially 0.

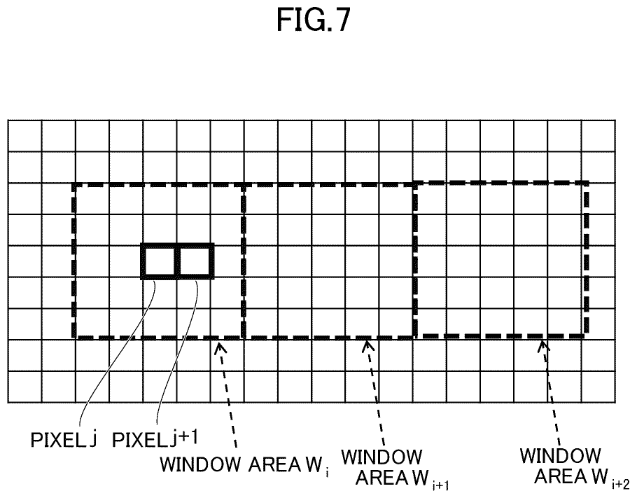

The depth calculating unit 11c calculates a deviation value for a window area Wᵢ including a plurality of pixels, and sets the deviation value as an energy function (S104). The window area Wᵢ may correspond to the unit area of the depth map. For example, as shown in FIG. 7, the depth calculating unit 11c calculates a deviation value for a window area Wᵢ including 5×5 pixel group. A plurality of window areas W are defined in the depth map. Such a calculation of the depth calculating unit 11c is represented by Mathematical formula 3 below, for example. In Mathematical formula 3, the energy function E_{n_i} the window area Wᵢ may be a mean value of the squares of the deviation value eₙ(j) calculated for the pixels (j) included in the window area Wᵢ.

$${E}_{n \_ i} \approx {\sum }_{j ∈ {W}_{i}} {{e}_{n} ( j )}^{2} \qquad Mathematical formula 3$$

E_{n_i} energy function for the window area Wᵢ (deviation value of window area Wᵢ)
eₙ(j): deviation value eₙ calculated for the j-th pixel included in the window area Wᵢ
subscript “n”: a natural number corresponds to a reference depth

The energy function Eₙ is calculated for each of a plurality of preset reference depths. The depth calculating unit 11c calculates a reference depth that minimizes the energy function Eₙ as an estimated depth (S105). The depth calculating unit 11c calculates the estimated depth for each window area Wᵢ.

In S105, when evaluating the energy function Eₙ, for example, Mathematical formula 4 below may be referred to, and the size (magnification) of the PSF corresponding to the energy function Eₙ may be taken into account. In the following, “weight λₙ×energy function E_{n_i}” will be referred to as an evaluation value.

$${D}_{i} = {arg min}_{n} {λ}_{n} {E}_{n \_ i} \qquad Mathematical formula 4$$

Dᵢ: an estimated depth of a window area Wᵢ
λₙ: a weight trained by a use of an image having a known depth so as to minimize an error (misclassification) of the estimated depth due to the size (magnification) of the PSF
E_{n_i} energy function (deviation value) for window area Wᵢ

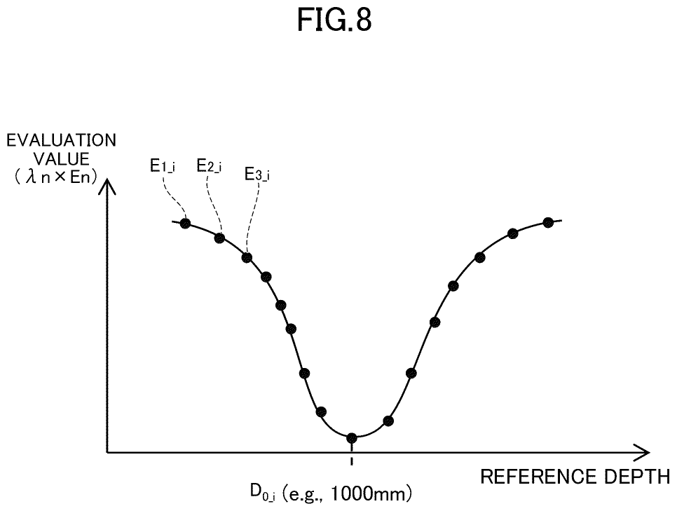

FIG. 8 is a diagram for describing such processing by the depth calculating unit 11c. In FIG. 8, the horizontal axis represents a reference depth, and the vertical axis represents an evaluation value (weight λₙ multiplied by the energy function E_{n_i}) calculated for a certain window area Wᵢ. The evaluation value is the smallest at the reference depth (d) that is the same as or close to the actual depth. In the example shown in FIG. 8, the evaluation value is the smallest at the position of the reference depth: D_{o_i} (e.g., 1000 mm). As such, an object appearing in such a window area is estimated as being located in the position of 1000 mm from the imaging system N. In S105, the depth calculating unit 11c searches for a reference depth at which the evaluation value is the smallest, and sets the obtained reference depth as the estimated depth D_{o_i}.

The depth map calculation processing is not limited to the explained above. For example, the depth calculating unit 11c may obtain a function (e.g., cubic function) representing a relationship between the evaluation values (weight λₙ×energy function E_{n_i}) and the reference depths, and may calculate a reference depth for obtaining a minimum of the evaluation value as an estimated depth D_{o_i} from the function.

The depth calculating unit 11c determines whether the estimated depth has been calculated for all the window areas W (all the unit areas of the depth map) (S106). If there is a window area W for which the estimated depth has not been calculated, the depth calculating unit 11c returns to S104 and executes the subsequent processing. When the estimated depth is calculated for all the window areas W, the processing of the depth calculating unit 11c terminates. In this manner, the depth map can be obtained.

### Function of Aperture Pattern Having Semi-Transmissive Area

As described above referring to FIG. 5, the aperture pattern B of the coded aperture part 14a having the semi-transmissive area R2 may function in the same way as the two aperture patterns B1 and B2. This will be described below.

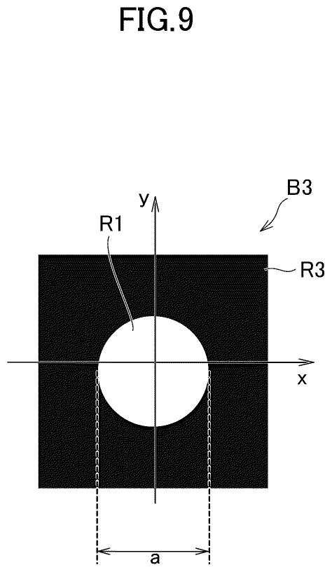

A general aperture pattern having no semi-transmissive area will be described. The aperture pattern B3 shown in FIG. 9 has a transmissive area R1 having a radius a at the central area. The aperture pattern B3 is expressed by Mathematical formula 5 below.

$$h ( x , y ) = \{ \begin{matrix}1 & ( \sqrt{{x}^{2} + {y}^{2}} < a ) & ( transmissive area ) \\ 0 & ( \sqrt{{x}^{2} + {y}^{2}} > a ) & ( shielding area )\end{matrix} \qquad Mathematical formula 5$$

In Mathematical formula 5, h=1 represents the transmissive area R1, and h=0 represents the shielding area R3. The two-dimensional Fourier transformation of the aperture pattern B3 represented by Mathematical formula 5 is represented by Mathematical formula 6 below in the polar coordinate system.

$$H ( {k}_{x} , {k}_{y} ) = {\int }_{0}^{2 π} {\int }_{0}^{a} {e}^{- jr ( {k}_{x} cos θ + {k}_{y} sin θ )} r d θ dr \qquad Mathematical formula 6$$

$$( x = r cos θ , y = r sin θ )$$

H: two-dimensional Fourier transformation of an aperture pattern represented by Mathematical formula 5
kₓ: angular frequency in x-direction, that is Value obtained by multiplying the spatial frequency in the x direction by 2π
k_{y}: angular frequency in y-direction, that is Value obtained by multiplying the spatial frequency in the y direction by 2π
a: aperture radius of aperture pattern B3 shown in FIG. 9

Mathematical formula 6 can be expressed by Mathematical formula 7 below using the Bessel function. In Mathematical formula 7, J₁ represents a Bessel function of the first kind where n=1.

$$H ( {k}_{x} , {k}_{y} ) = \frac{2 π}{\sqrt{{k}_{k}^{2} + {k}_{y}^{2}}} {J}_{1} ( a \sqrt{{k}_{x}^{2} + {k}_{y}^{2}} ) a \qquad Mathematical formula 7$$

Mathematical formula 7 can be modified to Mathematical formula 8 below.

$$H ( {k}_{x} , {k}_{y} ) = 2 π {a}^{2} \frac{{J}_{1} ( a {k}_{r} )}{a {k}_{r}} ( {k}_{r} = \sqrt{{k}_{x}^{2} + {k}_{y}^{2}} ) \qquad Mathematical formula 8$$

Next, the aperture pattern B shown in FIG. 4 will be described. The aperture pattern B shown in FIG. 4 can be represented by Mathematical formula 9 below. As described above, the area R1 is the transmissive area in the aperture pattern B, the area R2 is the semi-transmissive area, and the area R3 is the shielding area.

$$Mathematical formula 9$$

$$h ( x , y ) = \{ \begin{matrix}1 & ( \sqrt{{x}^{2} + {y}^{2}} < a ) & ( transmissive area ) \\ \frac{1}{2} & ( a < \sqrt{{x}^{2} + {y}^{2}} < b ) & ( semi - transmissive area ) \\ 0 & ( b < \sqrt{{x}^{2} + {y}^{2}} ) & ( shielding area )\end{matrix}$$

h=1 indicates the transmissive area R1, h=½ indicates the semi-transmissive area R2, and h=0 indicates the shielding area R3.
a: radius of the transmissive area R1
b: radius of semi-transmissive area R2

Similarly to Mathematical formula 6, the two-dimensional Fourier transformation of the aperture pattern B represented by Mathematical formula 9 is represented by Mathematical formula 10 below in the polar coordinate system.

$$H ( {k}_{x} , {k}_{y} ) = {\int }_{0}^{2 π} {\int }_{0}^{a} {e}^{- jr ( {k}_{x} cos θ + {k}_{y} sin θ )} r d θ dr + \frac{1}{2} \times {\int }_{0}^{2 π} {\int }_{a}^{{b}_{{e}^{- jr \{ {k}_{x} cos θ + {k}_{y} sin θ )}}} r d θ dr \qquad Mathematical formula 10$$

In Mathematical formula 10, the first term on the right-hand side represents the transmissive area R1, and the second term on the right-hand side represents the semi-transmissive area R2. Mathematical formula 10 can be modified to the following Mathematical formula 11.

$$H ( {k}_{x} , {k}_{y} ) = \frac{1}{2} \times {\int }_{0}^{2 π} {\int }_{0}^{a} {e}^{- jr ( {k}_{x} cos θ + {k}_{y} sín θ )} r d θ dr + \frac{1}{2} \times {\int }_{0}^{2 π} {\int }_{0}^{b} {e}^{- jr 〈 {k}_{x} cos θ + {k}_{y} sin θ )} r d θ d r = \frac{1}{2} [ {H}_{a} ( {k}_{x} , {k}_{y} ) + {H}_{b} ( {k}_{x} , {k}_{y} ) ] \qquad Mathematical formula 11$$

In Mathematical formula 11, the first term on the right-hand side corresponds to a two-dimensional Fourier transformation of the aperture having the radius a with a light transmittance of 50% (i.e., aperture pattern B1 in FIG. 5), and the second term on the right-hand side corresponds to a two-dimensional Fourier transformation of the aperture pattern having the radius b with a light transmittance of 50% (i.e., aperture pattern B2 in FIG. 5). That is, Mathematical formula 11 indicates that the two-dimensional Fourier transformation of the aperture pattern B shown in FIG. 4 matches the sum of the two-dimensional Fourier transformation of the semi-transmissive area R1′ (see FIG. 5) having the radius a and the two-dimensional Fourier transformation of the semi-transmissive area R2′ of the radius (see FIG. 5) having the radius b. Accordingly, the coded aperture part 14a having the aperture pattern B shown in FIG. 4 may function as two coded aperture parts, each including semi-transmissive areas R1′ and R2′. As such, the images may be captured only one time through the coded aperture part 14a. PSF corresponding to aperture pattern having semi-transmissive area

The point spread function (PSF) expressing an image blur caused by the coded aperture part has a figure corresponding to the aperture pattern of the coded aperture part. It is known that the PSF of the image blur is represented by Mathematical formula 12 below using a function representing the aperture pattern and a magnification m.

$$k ( x , y ) = \frac{1}{{m}^{2}} h ( \frac{x}{m} , \frac{y}{m} ) \qquad Mathematical formula 12$$

k: point spread function (PSF) corresponding to an image blur caused by a coded aperture part
h: function representing the aperture pattern of the coded aperture part
m: magnification of the PSF (k) with respect to the aperture pattern (h) (that is, size of the blurred image when assuming the size of the aperture pattern is “1”). “m” is a value determined by the distance between the lens 15 and the object.

Accordingly, the PSF corresponding to the image blur caused by the aperture pattern B3 (see FIG. 9) is represented by Mathematical formula 13 below using Mathematical formula 12 and Mathematical formula 8 representing the aperture pattern B3.

$$K ( {k}_{x} , {k}_{y} ) = π {a}^{2} \frac{2}{{m}^{2}} \frac{{J}_{1} ( a {k}_{r} )}{a {k}_{r}} ( {k}_{r} = \sqrt{{k}_{x}^{2} + {k}_{y}^{2}} ) \qquad Mathematical formula 13$$

K: two-dimensional Fourier transformation of the PSF corresponding to the image blur caused by the coded aperture part
kₓ: angular frequency in x-direction
k_{y}: angular frequency in y-direction
J₁: Bessel function of the first kind where n=1
a: aperture radius of aperture pattern B3 shown in FIG. 9
m: magnification of the PSF (k) with respect to the aperture pattern (h) (that is, size of the blurred image when assuming the size of the aperture pattern is “1”). “m” is a value determined by the distance between the lens 15 and the object.

The two-dimensional Fourier transformation of the PSF corresponding to the image blur caused by the aperture pattern B shown in FIG. 4 is expressed by Mathematical formula 14 below using Mathematical formula 11, Mathematical formula 12, and Mathematical formula 13.

$$K ( {k}_{x} , {k}_{y} ) = \frac{π {a}^{2}}{{m}^{2}} \frac{{J}_{1} ( a {k}_{r} )}{a {k}_{r}} + \frac{π {b}^{2}}{{m}^{2}} \frac{{J}_{1} ( b {k}_{r} )}{b {k}_{Γ}} ( {k}_{r} = {k}_{x}^{2} + {k}_{y}^{2} ) \qquad Mathematical formula 14$$

As shown by Mathematical formula 14, the two-dimensional Fourier transformation of the PSF corresponding to the image blur caused by the aperture pattern B shown in FIG. 4 matches the sum of the two-dimensional Fourier transformation of the PSF corresponding to the image blur caused by the semi-transmissive area R1′ (see FIG. 5) having the radius a and the two-dimensional Fourier transformation of the PSF corresponding to the image blur caused by the semi-transmissive area R2′ (see FIG. 5) having the radius b. Multiple PSFs obtained through different magnifications m, namely, multiple PSFs corresponding to each reference depth are stored in the memory unit 12. These multiple PSFs are utilized in S102 and S103.

### Modified Examples

The generation system of the depth map described in the present disclosure is not limited to the generation system 10 described above, and various changes may be made.

For example, the aperture pattern of the coded aperture part 14a is not limited to the aperture pattern B shown in FIG. 4. The aperture pattern of the coded aperture part may have a plurality of transmissive areas R1 and/or a plurality of semi-transmissive areas R2.

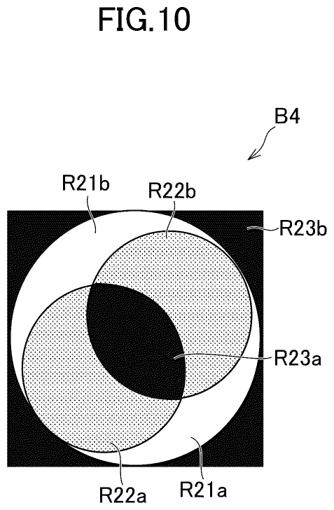

FIG. 10 shows a modified example of the aperture pattern. In FIG. 10, the aperture pattern B4 includes transmissive areas R21a and R21b, semi-transmissive areas R22a and R22b, and shielding areas R23a and R23b. The two semi-transmissive areas R22a and R22b are two circular areas of 50% transmittance overlapped with each other, in which the overlapping portion is removed. The overlapping portion of the two circles is the shielding areas 23a. The transmissive areas R21a and R21b are obtained by removing the two semi-transmissive areas R22a and R22b and the shielding area R23a from the circular area having a transmittance of 100%.

As yet another example, the aperture pattern of the coded aperture part 14a sets the light transmittance in three stages (T1, T2, T3). In this regard, the aperture pattern of the coded aperture part 14a may set the light transmittance in four or five stages. For example, in the aperture pattern of the coded aperture part 14a, the transmissive area R1 (light transmittance T1), the semi-transmissive area R2 (light transmittance T2<T1), and the semi-transmissive area R2′ (light transmittance T2′<T2) may have the shielding area R3 (light transmittance T3<T2′).

In the example described with reference to FIG. 6, the window area W including a plurality of pixels is defined, and the estimated depth is calculated assuming that the depth is uniform in the window area W. However, the method of calculating the estimated depth is not limited to this example. For example, an estimated depth may be calculated for each pixel of the captured image f.

### CONCLUSION

(1) As described above, the depth map generation system 10 proposed in the present disclosure includes a liquid crystal shutter 14 that forms a coded aperture part 14a, an imaging device 13 that captures light transmitted through the coded aperture part 14a, and a depth calculating unit 11c that uses a captured image f acquired by the imaging device 13 to calculate a depth for each unit area (window area W) of a depth map. The coded aperture part 14a includes aperture patterns B and B4 including a first area (transmissive area) R1 having a first light transmittance T1, a second area (semi-transmissive area) R2 having a second light transmittance T2 lower than the first light transmittance T1, and a third area (shielding area) R3 having a third light transmittance T3 lower than the second light transmittance T2.

According to the generation system 10, the number of times of capturing an object required for generating a depth map can be set to one, for example, and situations in which the generation system is used can be thereby increased. Further, even with a single aperture pattern, it is possible to suppress the occurrence of frequency where the power spectrum becomes zero when generating a restored image using the PSF.

(2) In the generation system 10 of (1), the first light transmittance T1 is an upper limit of a light transmittance that is feasible by the liquid crystal shutter 14, the third light transmittance T3 is a lower limit of a light transmittance that is feasible by the liquid crystal shutter 14, and the second light transmittance T2 is a transmittance between the first light transmittance and the third light transmittance.

(3) In the generation system 10 of (1) or (2), the second transmittance is between 40 percent and 60 percent when the first transmittance is 100 percent and the third transmittance is 0 percent.

(4) In the generation system 10 of any one of (1) to (3), the second transmittance is substantially 50 percent when the first transmittance is 100 percent and the third transmittance is 0 percent.

(5) In the generation system 10 of any one of (1) to (4), the first area (transmissive area) R1 and the second area (semi-transmissive area) R2 are circular with a same center.

(6) In the generation system 10 of any one of (1) to (5), the aperture pattern B4 of the coded aperture part 14a includes a plurality of the first areas (transmissive areas) R1.

(7) In the generation system 10 of any one of (1) to (5), the aperture pattern B4 of the coded aperture part 14a includes a plurality of the second areas (semi-transmissive areas) R2.

(8) In the generation system 10 of (6), the aperture pattern B4 of the coded aperture part 14a includes a plurality of the second areas (semi-transmissive areas) R2.

(9) In the generation system 10 of any one of (1) to (8), the depth calculating unit 11c acquires a plurality of PSFs respectively corresponding to a plurality of reference depths set discretely and corresponding to the aperture patterns B and B4, calculates a deviation value (Eₙ) for each unit area of the depth map with respect to a plurality of reference depth restored images, each of the reference depth restored images being generated based on the captured image f with a use of a PSF among the plurality of PSFs, the deviation value indicating degree of deviation between the reference depth and an actual depth in an unit area, calculates a depth for each unit area of the depth map based on the deviation value (Eₙ).

(10) A method for generating a depth map proposed in the present disclosure includes the steps of forming a coded aperture part 14a with a use of a liquid crystal shutter 14, capturing light transmitted through the coded aperture part 14a, and using a captured image f acquired by the imaging device 13 to calculate a depth for each unit area (window area W) in the depth map. In the step of forming the coded aperture part 14a, aperture patterns B and B4 including a first area (transmissive area R1) having a first light transmittance T1, a second area (semi-transmissive area R2) having a second light transmittance T2 lower than the first light transmittance T1, and a third area (shielding area R3) having a third light transmittance T3 lower than the second light transmittance T2 is formed.

(11) A program proposed in the present disclosure causes a computer to function as means for forming a coded aperture part 14a with a use of a liquid crystal shutter 14, means for capturing light transmitted through the coded aperture part 14a, and means for using a captured image f acquired by the imaging device 13 to calculate a depth for each unit area of the depth map. The means for forming the coded aperture part 14a forms aperture patterns B and B4 including a first area (transmissive area R1) having a first light transmittance T1, a second area (semi-transmissive area R2) having a second light transmittance T2 lower than the first light transmittance T1, and a third area (shielding area R3) having a third light transmittance T3 lower than the second light transmittance T2 is formed.

Although the present invention has been illustrated and described herein with reference to embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A system for generating a depth map, comprising:
a liquid crystal shutter that forms a coded aperture part;
an imaging device that captures light transmitted through the coded aperture part; and
a depth calculating unit that uses a captured image acquired by the imaging device to calculate a depth for each unit area of a depth map, wherein
the coded aperture part includes an aperture pattern that includes a first area, a second area, and a third area, the first area having a first light transmittance, the second area having a second light transmittance lower than the first light transmittance, the third area having a third light transmittance lower than the second light transmittance.

2. The system for generating the depth map according to claim 1, wherein
the first light transmittance is an upper limit of a light transmittance that is feasible by the liquid crystal shutter,
the third light transmittance is a lower limit of a light transmittance that is feasible by the liquid crystal shutter, and
the second light transmittance is a transmittance between the first light transmittance and the third light transmittance.

3. The system for generating the depth map according to claim 1, wherein
the second transmittance is between 40 percent and 60 percent when the first transmittance is defined as 100 percent and the third transmittance is defined as 0 percent.

4. The system for generating the depth map according to claim 1, wherein
the second transmittance is substantially 50 percent when the first transmittance is defined as 100 percent and the third transmittance is defined as 0 percent.

5. The system for generating the depth map according to claim 1, wherein
the first area and the second area are circular with a same center.

6. The system for generating the depth map according to claim 1, wherein
the aperture pattern of the coded aperture part includes a plurality of the first areas.

7. The system for generating the depth map according to claim 1, wherein
the aperture pattern of the coded aperture part includes a plurality of the second areas.

8. The system for generating the depth map according to claim 6, wherein
the aperture pattern of the coded aperture part includes a plurality of the second areas.

9. The system for generating the depth map according to claim 1, wherein
the depth calculating unit:
acquires a plurality of point spread functions (PSFs) respectively corresponding to a plurality of reference depths and corresponding to the aperture pattern, the plurality of reference depths being set discretely;
calculates a deviation value for each unit area of the depth map with respect to a plurality of reference depth restored images, each of the reference depth restored images being generated based on the captured image with a use of a PSF among the plurality of PSFs, the deviation value indicating degree of deviation between the reference depth and an actual depth in an unit area; and
calculates a depth for each unit area of the depth map based on the deviation value.

10. A method for generating a depth map comprising the steps of:
forming a coded aperture part with a use of a liquid crystal shutter;
capturing light transmitted through the coded aperture part; and
using a captured image acquired by the imaging device to calculate a depth for each unit area in the depth map, wherein
an aperture pattern that includes a first area, a second area, and a third area is formed in the step of forming the coded aperture part, the first area having a first light transmittance, the second area having a second light transmittance lower than the first light transmittance, the third area having a third light transmittance lower than the second light transmittance.

11. A non-transitory information storage medium storing a program that causes a computer to function as:
means for forming a coded aperture part with a use of a liquid crystal shutter;
means for capturing light transmitted through the coded aperture part; and
means for using a captured image acquired by the imaging device to calculate a depth for each unit area of the depth map, wherein
the means for forming the coded aperture part forms an aperture pattern that includes a first area, a second area, and a third area, the first area having a first light transmittance, the second area having a second light transmittance lower than the first light transmittance, the third area having a third light transmittance lower than the second light transmittance.
